(19) United States
(12) Patent Application Publication
(10) Pub. No.: US 2007/0028496 A1
(43) Pub. Date: Feb. 8, 2007

(54) Postcard with sound recording and a player therefor

(76) Inventor: Dusan Zizek, Murska Sobota (SI)

Correspondence Address: JACOBSON HOLMAN PLLC, 400 SEVENTH STREET N.W., SUITE 600, WASHINGTON, DC, 20004, US

(21) Appl. No.: 10/555,649

(22) PCT Filed: Nov. 3, 2004
(86) PCT No.: PCT/SI04/00035

§ 371 Date: Nov. 4, 2005

(30) Foreign Application Priority Data
Nov. 5, 2003 (SI) P-200300269

(51) Int. Cl. B42D 15/00

(52) U.S. Cl. 40/717; 229/92.8

(57) ABSTRACT

A postcard with sound recording and a player therefor allows discrete, even multiple sending of a content and listening to the content via an adequate player and a security pin. The postcard of the invention is made as an optional postcard (1), one side of which is optionally graphically designed, for instance bearing a photo, and on the other side there is a field for an address and a message field, where an electronic device (2) is placed, which is intended to receive, store and transmit a voice message and consists of a microphone, a processing unit, a memory unit and a power source, e.g. a battery, whereby the electronic device (2) is linked to a manual switch (3) for message recording and a pin (4) that is also linked to a sound player (5) and a set of switches (6) for the entry of a security pin into the electronic device (2), whereas the entered security pin is simultaneously also the key for transmission of the sound recording in the player (5), whereas switches (3 and 6) as well as the microphone of the electronic device are covered each by two sheets, namely a directly accessible sheet (7) and a security sheet (8) lying underneath the sheet (7), said sheet (8) being replaceable.

### SUBJECT OF INVENTION

The subject of the invention is a postcard with sound recording and a player therefor.

### TECHNICAL PROBLEM

A technical problem solved by the invention is how to conceive a postcard with sound recording, which would allow discrete, even multiple sending of a content and listening to the content via an adequate player.

### PRIOR ART

We know several types of postcards containing an electronic device for reception, storage and transmission of voice messages. A characteristic of these devices lies in the message being available to anyone. Thus discrete nature of access to the message is not granted.

There is a need for a postcard, which would grant access to sound content only to those persons, to whom the message is dedicated.

### SOLUTION TO THE TECHNICAL PROBLEM

The described technical problem is solved by the new postcard of the invention, the essential novelty of which lies in that the postcard with an electronic device for reception, storage and reproduction of a message is conceived in a way to allow reproduction of a message only with a special sound player, which is capable of reading a message only if the safety pin encoded in a message overlaps with the pin entered by the person, who wants to listen to the message in the player, whereby this person has received the adequate pin from the sender on a postcard by separate mail.

The sound player can have additional functions, such as storing messages, repeated playing, access to messages linked to various pins, etc.

In order that the present invention be more readily understood, an embodiment thereof will now be described by way of example with reference to the accompanying drawing in which:

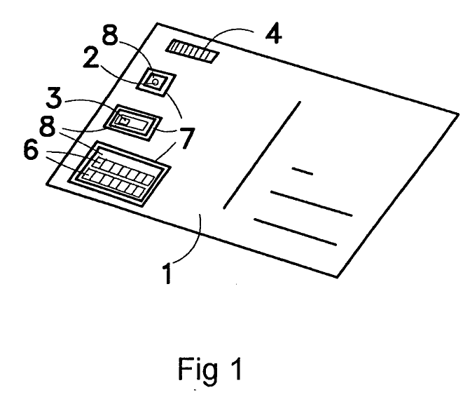

FIG. 1 shows a perspective view of a postcard with a device for reception, storage and transmission of a voice message.

A postcard with a voice message and a player therefor is made as an optional postcard 1, one side of which is optionally graphically designed, for instance bearing a photo, and on the other side there is a field for an address and a message field, where an electronic device 2 is placed, which is intended to receive, store and transmit a voice message. This device consists of a microphone, a processing unit, a memory unit and a power source, e.g. a battery. The electronic device 2 is linked to a manual switch 3 for message recording and a pin 4 that is also linked to a sound player 5. The postcard is equipped with a set of switches 6 for the entry of a security pin into the electronic device 2, which ensures that the message is read via an adequate voice player only by the person who has received the pin by separate mail and, when entered into the player, triggers voice playing.

The switch 3 for manual recording on the postcard and the microphone of the electronic device 2 are covered each with two sheets, positioned one after another. An upper sheet 7 is directly accessible and acts as a sealing sheet. It can only be removed once and gets mechanically changed, without any possibility of restoration. Another sheet 8 lies underneath the sealing sheet 7 and protects the switch and the microphone against impacts and influences when they are not in operation mode. This sheet 8 can only be partly removed and re-placed to its original position to cover the switch or microphone.

Switches 6 for the entry of a pin into the electronic device 2 are also covered each by two sheets 7 and 8. The upper sheet 7 acts as a sealing sheet and is removable, whereas the lower sheet 8 acts as a security sheet and is replaceable over the switches after the pin is entered into the device 2.

The device of the invention operates as follows: we first check whether the sealing sheets 7 on the postcard are undamaged and placed on the switch 3 for recording, on the microphone and the switches 6 for pin entry. This is an indication that the postcard has not been used. When removing the sealing sheet 7 from the switches 6 to enter the pin, we see the security sheet 8, which must be partly removed in order to access the switches to enter the pin into the device 2. The number of switches 6 is optional. Preferably, there are up to 10 switches, 5 with numbers and 5 with letters, which are always used to generate one's own pin consisting of four or five characters. After the pin is entered into the electronic device 2 and confirmed with an adequate character, the switches 6 are covered with the sheet 8.

The sheet 7 and partly the sheet 8 are removed from the switch 3 to enter recording, to access the switch 3 and the microphone of the electronic device 2. The switch 3 is preferably of a shape to entirely fit the thickness of a postcard. After the switch 3 is manually turned on, a message is dictated into the microphone. Dictation can be temporarily interrupted several times by temporarily turning the switch 3 off. After the completion of the message entry, the switch 3 is turned off and re-covered by the protecting sheet 8, which prevents the switch 3 from being unintentionally turned on. A simple protecting sheet 8 is used to cover the microphone to provide mechanical protection.

Another part of the entire device is a sound player 5, which is an indispensable unit to play the message via connector 4 on the postcard, which transmits the data from the electronic device 2 on the postcard into the player 5, yet only when the correct pin is entered into the player. As mentioned earlier, the pin is sent to the message receiver by the sender separately (e.g. by phone, fax, etc.). In case of a repeated entry of a wrong pin, the player erases the content in the postcard, because it assumes an unauthorized person intends to read the message.

The player further contains an optional message editor, which edits messages by various criteria; moreover there is a possibility of forwarding the messages to new addresses, which is, however, no longer subject of this invention.

The player can be used for reading and editing of messages of several persons or rather on the basis of various pins.

The player can also be used to erase messages on the postcard, which becomes reusable for entry, storing and transmission of a new message.

The length of a message, which can be entered into the electronic device in the postcard, is optional, preferably up to 180 seconds.

It is understandable that the shape of a postcard and of the switches as well as other elements of the invention and their arrangement on the postcard are optional and it is understandable that a person skilled in the art can design other embodiments of the postcard of the invention without circumventing novelty and characteristics of the invention defined in the attached patent claims.

1: Postcard with a voice message and a player therefor, whereby the postcard is made as an optional postcard (1), one side of which is optionally graphically designed, for instance bearing a photo, and on the other side there is a field for an address and a message field, where an electronic device (2) is placed, intended to receive, store and transmit a voice message, and consists of a microphone, a processing unit, a memory unit and a power source, e.g. a battery, characterized in that the electronic device (2) is linked to a manual switch (3) for message recording and a pin (4) for connection with a sound player (5) and a set of switches (6) for the entry of a security pin into the electronic device (2), whereby the entered security pin at the same time acts as a key for the reproduction of a sound recording in the player (5).

2: Postcard according to claim 1, characterized in that the switch (3) for manual recording on the postcard and the microphone of the electronic device (2) are covered each with two sheets, positioned one after another, whereby an upper sheet (7) is directly accessible and can only be removed once without any possibility of restoration of the sealing, whereas another sheet (8) lies underneath the sheet (7) functioning as protection of the switch and the microphone against impacts and influences when they are not in operation mode, whereby the sheet (8) can only be partly removed and replaced to its original position to cover the switch or microphone.

3: Postcard according to claim 1, characterized in that switches (6) for the entry of a pin into the electronic device (2) are also covered each by two sheets (7 and 8), whereby the upper sheet (7) acts as a sealing sheet, whereas the lower sheet (8) acts as a security sheet and is replaceable over the switches after the pin is entered into the device (2).

4: Postcard according to claim 1, characterized in that the number of switches 6 is optional, preferably up to 10 switches, 5 with numbers and 5 with letters.

5: Postcard according to claim 1, characterized in that a sound player (5) is an indispensable unit to play the message and that only when the correct pin is entered into the player, said pin being obtained by the receiver from the sender by separate mail.

6: Postcard according to claim 1, characterized in that information from the postcard (1) is transferred into the player (5) via a connector (4) on the postcard.

7: Postcard according to claim 1, characterized in that the player (5) further contains an optional message editor, which edits messages by various criteria, moreover there is a possibility of forwarding the messages to new addresses.

8: Postcard according to claim 1, characterized in that the player (5) allows erasing of a message in the postcard via its message editor in order to render the postcard reusable.
